(19) United States
(12) Patent Application Publication
(10) Pub. No.: US 2013/0286327 A1
(43) Pub. Date: Oct. 31, 2013

(54) Backlight Module and Liquid Crystal Display Module

(71) Applicant: Jianfa Huang, Shenzhen (CN)

(72) Inventor: Jianfa Huang, Shenzhen (CN)

(73) Assignee: SHENZHEN CHINA STAR OPTOELECTRONICS TECHNOLOGY CO. LTD, Shenzhen (CN)

(21) Appl. No.: 13/512,341

(22) PCT Filed: May 4, 2012
(86) PCT No.: PCT/CN12/75067

§ 371 Date: May 28, 2012

(30) Foreign Application Priority Data
Apr. 27, 2012 (CN) 201210128649.2

(51) Int. Cl. F21V 13/12; G02F 1/13357; F21V 29/00

(52) U.S. Cl. 349/65; 362/606

(57) ABSTRACT

The present invention provides a backlight module configured with a waveguide including an incident surface, and a refractive surface adjacent to the incident surface, and a bottom surface opposite to the refractive surface. A light source is included to provide projected light beam into the incident surface of the waveguide through a deflector. A backframe is disposed on below the bottom surface of the waveguide. And Wherein the deflector is formed by an extension of the backframe extending from an edge of the backframe adjacent to the incident surface, the extension further extending along the incident surface. By the configuration provided, material cost can be lowered, while optical performance of the parts can be stabilized. Coupling between the light source and the waveguide is enhanced.

### FIELD OF THE INVENTION

The present invention relates to a technical field of liquid crystal display, and more particularly to a backlight module and a liquid crystal display incorporated with the backlight module made in accordance with the present invention.

### DESCRIPTION OF PRIOR ART

As shown in FIG. 1, in the so-called vertical-type of backlight module, it generally includes a waveguide 11, an aluminum excursion 12, a backboard 13, a deflector 14, a light source 15, and an optical film 16. The deflector 14 is disposed on a plastic frame 17 facing the light source 15. The light source 15 is disposed within a compartment (not shown) of the aluminum excursion 12. The light emitted from the light source 15 will be projected into the waveguide 11 after deflected by the deflector 14.

The plastic frame 17 is made from general plastic material, and it tends to deform when external force exerted thereon. As a result, the deflector 14 may readily peel off from the deflector 14. As a result, this will negatively influence the coupling between the light source 15 and the waveguide 11.

Accordingly, it is necessary to provide a backlight module and liquid crystal display to resolve the problem encountered by the prior arts.

### SUMMARY OF THE INVENTION

A technical issue to be resolved by a backlight module and a liquid crystal display module provided by the present invention. Optical performance of the parts can be stabilized. Coupling between the light source and the waveguide is enhanced.

In order to resolve the prior art issue, a technical solution provided by the present invention is introduced by having a backlight module with a waveguide including an incident surface, and a refractive surface adjacent to the incident surface, and a bottom surface opposite to the refractive surface. A light source is included to provide projected light beam into the incident surface of the waveguide through a deflector. A backframe is disposed on below the bottom surface of the waveguide. Wherein the deflector is formed by an extension of the backframe extending from an edge of the backframe adjacent to the incident surface, the extension further extending along the incident surface. Wherein an end of the deflector in abutting against an transitional edge located between the incident surface and the refractive surface: and wherein a surface of the deflector is provided with a refractive mirror or a metallic layer.

Wherein the deflector has a planar configuration and has an angle ranging from twenty (20) to seventy (70) degrees with respect to a horizontal direction.

In order to resolve the prior art issue, a technical solution provided by the present invention is introduced with a backlight module configured with a waveguide including an incident surface, and a refractive surface adjacent to the incident surface, and a bottom surface opposite to the refractive surface. A light source is included to provide projected light beam into the incident surface of the waveguide through a deflector. A backframe is disposed on below the bottom surface of the waveguide. And Wherein the deflector is formed by an extension of the backframe extending from an edge of the backframe adjacent to the incident surface, the extension further extending along the incident surface.

Wherein the backframe includes a heatsink and a backboard. The heatsink is disposed under the bottom surface of the waveguide. The backboard is disposed under the heatsink so as to support the waveguide, the light source and the heatsink; and wherein the heatsink includes a base interconnected to the deflector, the base of the heatsink is parallel to the bottom of the waveguide, the base defines a compartment for receiving the light source, the compartment includes a sidewall abutting against to the sidewall of the backboard, the reflector extends and curves from the sidewall and along the incident surface.

Wherein the heatsink is configured from an aluminum extrusion, and the base of the heatsink is integrally formed with the deflector

Wherein the backframe includes a heatsink and a backboard. The heatsink is disposed under the bottom surface of the waveguide. The backboard is disposed under the heatsink so as to support the waveguide, the light source and the heatsink. Wherein the heatsink defines a compartment for receiving the light source in an area adjacent to the incident surface of the waveguide. And the backboard includes a main slab which is parallel to the bottom surface of the heatsink, and a sidewall perpendicular to the main slab, the deflector extends and curves from the sidewall toward the incident surface of the waveguide.

Wherein the main slab, the sidewall and the deflector are integrally formed together.

Wherein the light source includes a printed circuit board and an LED unit, the printed circuit is disposed closely to a bottom of the compartment, and the LED is disposed on a top surface of the printed circuit board.

Wherein an end of the deflector in abutting against a transitional edge located between the incident surface and the refractive surface.

Wherein a surface of the deflector is provided with a refractive mirror or a metallic layer.

Wherein the deflector has a planar configuration and has an angle ranging from twenty (20) to seventy (70) degrees with respect to a horizontal direction.

In order to resolve the prior art issue, a technical solution provided by the present invention is introduced with a liquid crystal display configured with a liquid crystal display panel and a backlight module providing light source to the liquid crystal display panel. The backlight module comprises a waveguide including an incident surface, and a refractive surface adjacent to the incident surface, and a bottom surface opposite to the refractive surface. A light source is provided to emit a projected light beam into the incident surface of the waveguide through a deflector. A backframe is disposed on below the bottom surface of the waveguide; and wherein the deflector is formed by an extension of the backframe extending from an edge of the backframe adjacent to the incident surface, the extension further extending along the incident surface.

Wherein the backframe includes a heatsink and a backboard. The heatsink is disposed under the bottom surface of the waveguide. The backboard is disposed under the heatsink so as to support the waveguide, the light source and the heatsink; and wherein the heatsink includes a base interconnected to the deflector, the base of the heatsink is parallel to the bottom of the waveguide, the base defines a compartment for receiving the light source, the compartment includes a sidewall abutting against to the sidewall of the backboard, the reflector extends and curves from the sidewall and along the incident surface.

Wherein the heatsink is configured from an aluminum extrusion, and the base of the heatsink is integrally formed with the deflector.

Wherein the backframe includes a heatsink and a backboard. The heatsink is disposed under the bottom surface of the waveguide. The backboard is disposed tinder the heatsink so as to support the waveguide, the light source and the heatsink. Wherein the heatsink defines a compartment for receiving the light source in an area adjacent to the incident surface of the waveguide. The backboard includes a main slab which is parallel to the bottom surface of the heatsink, and a sidewall perpendicular to the main slab, the deflector extends and curves from the sidewall toward the incident surface of the waveguide.

Wherein the heatsink is configured from an aluminum extrusion, and the base of the heatsink is integrally formed with the deflector.

Wherein the light source includes a printed circuit board and an LED unit, the printed circuit is disposed closely to a bottom of the compartment, and the LED is disposed on a top surface of the printed circuit board.

Wherein an end of the deflector in abutting against a transitional edge located between the incident surface and the refractive surface.

Wherein a surface of the deflector is provided with a refractive mirror or a metallic layer.

Wherein the deflector has a planar configuration and has an angle ranging from twenty (20) to seventy (70) degrees with respect to a horizontal direction.

The present invention can be concluded with the following advantages. As compared with the existing prior art, the deflector is formed by an extension of the backframe extending from an edge of the backframe adjacent to the light source. The deflector, waveguide and the backframe jointly define a reflective chamber with simplified configuration. Since the deflector does not carry any other part of the backframe thereby is immune from any deformation so as to enhance the stability of the optical parts within the backlight module. The coupling between the light source and the waveguide is also increased. In addition, the deflector is an extension from the backframe and the part for the backframe is also reduced.

### BRIEF DESCRIPTION OF DRAWINGS

FIG. 1 is an illustrational view of a prior art backlight module;

FIG. 2 is an illustrational view of a backlight module made in accordance with a first embodiment of the present invention;

FIG. 3 is an illustrational view of a backlight module made in accordance with a second embodiment of the present invention;

FIG. 4 is an illustrational view of a backlight module made in accordance with a third embodiment of the present invention;

### DETAILED DESCRIPTION OF PREFERRED EMBODIMENT

Detailed description in view of a preferred embodiment will be given with the illustration of the accompanied drawings.

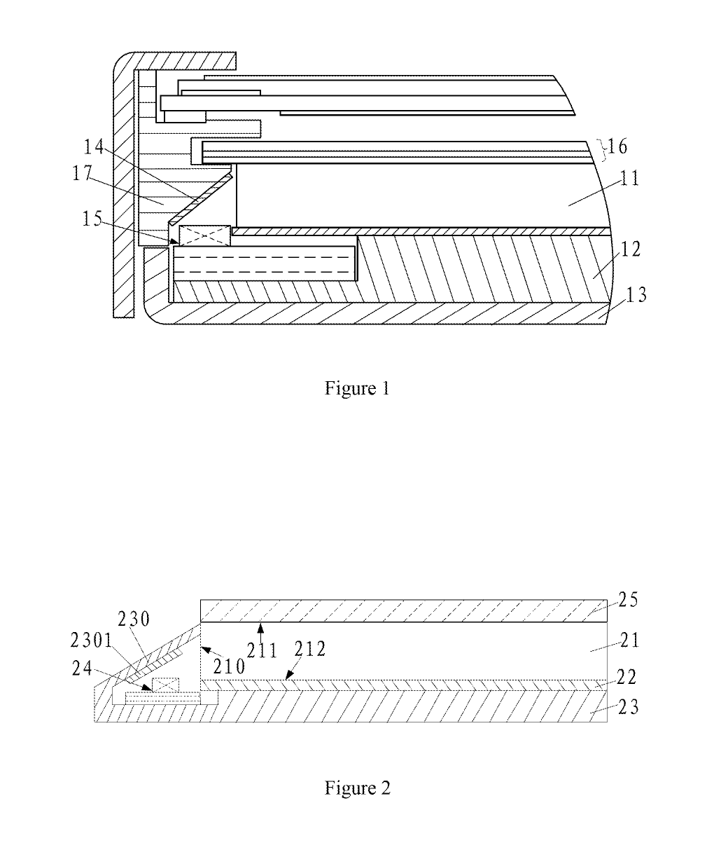

Referring to FIG. 2, an illustrational configuration of a backlight module made in accordance with the first embodiment of the present invention. According to the present invention, the backlight module generally includes a waveguide 21, a reflector 22, a backframe 23, a light source 23, and an optical film 25. The optical film 25, the waveguide 21, the reflector 22, and the backframe 23 are arranged in sequence from top to bottom.

Substantially, the waveguide 21 including an incident surface 210, and a refractive surface 211 adjacent to the incident surface 210, and a bottom surface 212 opposite to the refractive surface 211.

The reflector 22 is disposed under the bottom surface 212 of the waveguide 21. The incident light beam from the incident surface 210 of the waveguide 21 will be reflected and then emitted from the reflective surface 211 so as to increase the utilization of the light.

The backframe 23 is disposed under the bottom surface 212 of the waveguide 21, and is located under the reflector 22. The backframe 23 further includes a deflector 230 which is formed by an extension of the backframe 23 extending from an edge of the back frame along the incident surface 210 the waveguide 21.

The light beam projected from the light source 24 will be deflected by the deflector 230 and then enters into the waveguide 21 through the incident surface 210.

The optical film 25 can be a diffuser and an optical enhancer which is deployed over the reflective surface 211 of the waveguide 21. The optical film 25 will make the light beam projected from the waveguide 21 more evenly distributed across the waveguide 21.

It should be noted that in the current embodiment, an end of the deflector 230 abuts against a transitional edge adjoining the incident surface 210 and the reflective surface 211 of the waveguide 21. The deflector 230 is further provided with a light enhancing unit 2301 which can be embodied from a mirror or reflective layer with high refractive index so as to enhance the refractive rate of the deflector 230.

From the above description, it can be readily acknowledged that the deflector 230, the waveguide 21, and the backframe 23 jointly define a reflective chamber (not labeled). Because the reflective chamber has an excellent airtight capability, the light beam emitted from the light source 24 can effectively travel within the chamber. Since the leakage of the light beam is too few to be counted, and the coupling between the light source 24 and the waveguide 21 is therefore upgraded.

In the above described embodiment, the deflector 230 has a planar configuration, and an angle between the deflector 230 and the horizontal direction varies between twenty (20) to seventy (70) degrees. Preferred, the angle can be thirty (30) degrees, forty-five (45) degrees, or sixty (60) degrees.

In the present invention, the deflector 230 is formed by an extension of the backframe 23 extending from an edge of the backframe 23 adjacent to the incident surface 210 of the waveguide 21. The extension further extends along the incident surface 210. In addition, since the deflector 230, the waveguide 21, and the backframe 23 jointly define the refractive chamber of simplified configuration. Since the deflector 230 does not carry or support any weight from other parts, there is very low possibility of deformation. As a result, this can enhance the overall stability of the optical elements. The coupling between the light source 24 and the waveguide 21 is also enhanced. In addition, since the deflector 230 is formed by an extension from the backframe 23, no additional part is needed. This will also reduce the overall cost.

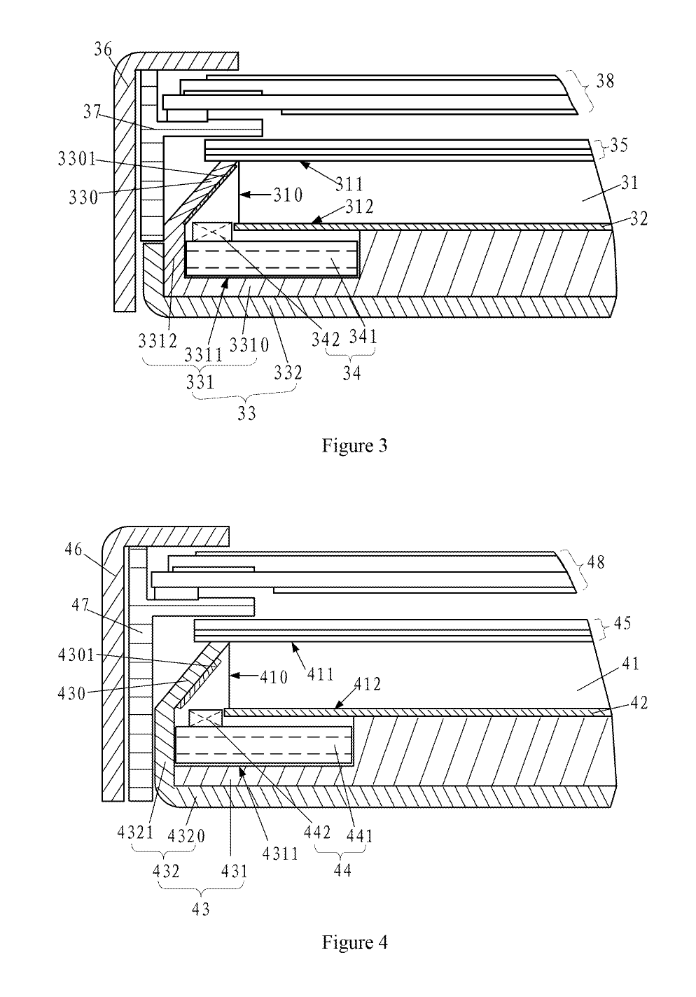

Referring to FIG. 3, an illustrational configuration of a backlight module made in accordance with a second embodiment is shown. The backlight module includes a waveguide 31, a reflector 32, a backframe 33, a light source 34, and an optical film 35. All of these elements are functionally equivalent to those parts disclosed in the first embodiment. The backlight module further includes a heatsink 331 and a backboard 332.

The heatsink 331 is disposed under a bottom surface 312 of the waveguide 31, and the backboard 332 is located under the heatsink 331 for carrying and supporting the waveguide 31, the heatsink 331 and the light source 34.

The heatsink 331 further includes a base 3310 interconnected to a deflector 330. The base 3310 and the waveguide 31 are parallel to each other. The base 3310 further defines a compartment 3311 for receiving the light source 34 therein. The compartment 3311 includes a sidewall 3312 abutting a sidewall of the backboard 332. The deflector 330 extends and curves from the sidewall 3312 of the base 331 along an incident surface 310 of the waveguide 31. Of course, the deflector 330 can be incorporated with reflective enhancer 3301 which can be embodied as a mirror or a metallic layer having highly refractive index.

In one of the preferred embodiments, the heatsink 33 I is made from an aluminum excursion, and the base 3310 of the heatsink 331 and the deflector 330 are integrally formed. Of course, the heatsink 331 can be embodied with other alternative metal or aluminum alloy depending on field requirements, for example, copper plates can be used to configure the heatsink.

The light source 34 further includes a printed circuit board 341 and an LED unit 342. The printed circuit board 341 is closely disposed on a bottom of the compartment 3311, and the LED unit 342 is arranged on a surface of the printed circuit board 341.

It should be noted that the backlight module can be further supported by a steel frame 36 and a plastic frame 37 so as to realize a marriage with a liquid crystal display panel 38 to configure a liquid crystal display device.

In this embodiment, the deflector 330 is formed by an extension from the base 3310 of the heatsink 331, and it is integrally formed with the base 3310 to facilitate a simplified configuration. Since the deflector 330 does not carry or support any weight from other parts, there is very low possibility of deformation. As a result, this can enhance the overall stability of the optical elements. The coupling between the light source 34 and the waveguide 31 is also enhanced. In addition, since the deflector 330 is formed by an extension from the base 3310 of the heatsink 331, no additional part is needed. This will also reduce the overall cost. In addition, the configuration is also beneficial to heat dissipation.

referring now to FIG. 4, a third embodiment of a backlight module made in accordance with the present invention is disclosed. The backlight module includes a waveguide 41, a reflector 42, a backframe 43, a light source 44, and an optical film 45. All of these elements are functionally equivalent to those parts disclosed in the first embodiment. The backlight module further includes a heatsink 431 and a backboard 432.

The heatsink 431 is disposed under a bottom surface 412 of the waveguide 41, and the backboard 432 is located under the heatsink 431 for carrying and supporting the waveguide 41, the heatsink 431 and the light source 44. The heatsink 431 further defines a compartment 4311 for receiving the light source 44. The compartment 4431 is located adjacent to an incident surface 410 of the waveguide 41.

The backboard 432 includes a main slab 4320 arranged in parallel with a bottom surface of the heatsink 431, and a sidewall 4321 which is perpendicular to the main slab 4320. The deflector 430 extends and curves from the sidewall 4321 to an incident surface 410 of the waveguide 41.

In the above described configuration, the deflector 430 has a planar configuration and has an angle with respect to a horizontal direction. An angle between the deflector 230 and the horizontal direction varies between twenty (20) to seventy (70) degrees. Preferred, the angle can be thirty (30) degrees, forty-five (45) degrees, or sixty (60) degrees.

A surface of the deflector 430 facing the light source 44 is incorporated with reflective enhancer 3301 which can be embodied as a mirror or a metallic layer having highly refractive index.

The backboard 432, the sidewall 4321 and the deflector 430 are integrally formed together.

The light source 44 further includes a printed circuit board 441 and an LED unit 442. The printed circuit board 441 is closely disposed on a bottom of the compartment 4311, and the LED unit 442 is arranged on a surface of the printed circuit board 441.

It should be noted that the backlight module can be further supported by a steel frame 46 and a plastic frame 47 so as to realize a marriage with a liquid crystal display panel 48 to configure a liquid crystal display device.

In this embodiment, the deflector 430 is formed by an extension from the sidewall 4321 of the backboard 432 and it is integrally formed with the main slab 4320 to facilitate a simplified configuration. Since the deflector 430 does not carry or support any weight from other parts, there is very low possibility of deformation. As a result, this can enhance the overall stability of the optical elements. The coupling between the light source 44 and the waveguide 41 is also enhanced. In addition, since the deflector 430 is formed by an extension from the backboard 432, no additional part is needed. This will also reduce the overall cost. In addition, the configuration is also beneficial to heat dissipation.

The present invention further provides a liquid crystal display device configured with a liquid crystal display panel and backlight module described above. The backlight module can be embodied by any one of the above described embodiments.

In the above described embodiment, the number of the deflector can be multiple, i.e. the front, rear, left and right positions each can be incorporated with a deflector in an edge between the incident surface and the refractive surface. Their common feature is that the deflector can be formed by an extension of the back frame extending from an edge of the backframe adjacent to the incident surface, the extension further extending along the incident surface. Since their configuration is similar to what has been described, and no details is given herebelow.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backlight module, comprising:
a waveguide including an incident surface, and a refractive surface adjacent to the incident surface, and a bottom surface opposite to the refractive surface;
a light source providing projected light beam into the incident surface of the waveguide through a deflector;
a backframe disposed on below the bottom surface of the waveguide;
wherein the deflector is formed by an extension of the backframe extending from an edge of the backframe adjacent to the incident surface, the extension further extending along the incident surface;
wherein an end of the deflector in abutting against an transitional edge located between the incident surface and the refractive surface; and
wherein a surface of the deflector is provided with a refractive mirror or a metallic layer.

2. The backlight module as recited in claim 1, wherein the deflector has a planar configuration and has an angle ranging from twenty (20) to seventy (70) degrees with respect to a horizontal direction.

3. A backlight module, comprising:
a waveguide including an incident surface, and a refractive surface adjacent to the incident surface, and a bottom surface opposite to the refractive surface;
a light source providing projected light beam into the incident surface of the waveguide through a deflector;
a backframe disposed on below the bottom surface of the waveguide; and
wherein the deflector is formed by an extension of the backframe extending from an edge of the backframe adjacent to the incident surface, the extension further extending along the incident surface.

4. The backlight module as recited in claim 3, wherein
the backframe includes a heatsink and a backboard;
the heatsink is disposed under the bottom surface of the waveguide;
the backboard is disposed under the heatsink so as to support the waveguide, the light source and the heatsink; and
therein the heatsink includes a base interconnected to the deflector, the base of the heatsink is parallel to the bottom of the waveguide, the base defines a compartment for receiving the light source, the compartment includes a sidewall abutting against to the sidewall of the backboard, the reflector extends and curves from the sidewall and along the incident surface.

5. The backlight module as recited in claim 4, wherein the heatsink is configured from an aluminum extrusion, and the base of the heatsink is integrally formed with the deflector.

6. The backlight module as recited in claim 3, wherein
the backframe includes a heatsink and a backboard;
the heatsink is disposed under the bottom surface of the waveguide;
the backboard is disposed under the heatsink so as to support the waveguide, the light source and the heatsink;
wherein the heatsink defines a compartment for receiving the light source in an area adjacent to the incident surface of the waveguide; and
the backboard includes a main slab which is parallel to the bottom surface of the heatsink, and a sidewall perpendicular to the main slab, the deflector extends and curves from the sidewall toward the incident surface of the waveguide.

7. The backlight module as recited in claim 6, wherein the main slab, the sidewall and the deflector are integrally formed together.

8. The backlight module as recited in claim 6, wherein the light source includes a printed circuit board and an LED unit, the printed circuit is disposed closely to a bottom of the compartment, and the LED is disposed on a top surface of the printed circuit board.

9. The backlight module as recited in claim 3, wherein an end of the deflector in abutting against a transitional edge located between the incident surface and the refractive surface.

10. The backlight module as recited in claim 3, wherein a surface of the deflector is provided with a refractive mirror or a metallic layer.

11. The backlight module as recited in claim 3, wherein the deflector has a planar configuration and has an angle ranging from twenty (20) to seventy (70) degrees with respect to a horizontal direction.

12. A liquid crystal display configured with a liquid crystal display panel and a backlight module providing light source to the liquid crystal display panel, the backlight module comprising:
a waveguide including an incident surface, and a refractive surface adjacent to the incident surface, and a bottom surface opposite to the refractive surface;
a light source providing projected light beam into the incident surface of the waveguide through a deflector;
a backframe disposed on below the bottom surface of the waveguide; and
wherein the deflector is formed by an extension of the backframe extending from an edge of the backframe adjacent to the incident surface, the extension further extending along the incident surface.

13. The liquid crystal display as recited in claim 12, wherein
the backframe includes a heatsink and a backboard;
the heatsink is disposed under the bottom surface of the waveguide;
the backboard is disposed under the heatsink so as to support the waveguide, the light source and the heatsink; and
wherein the heatsink includes a base interconnected to the deflector, the base of the heatsink is parallel to the bottom of the waveguide, the base defines a compartment for receiving the light source, the compartment includes a sidewall abutting against to the sidewall of the backboard, the reflector extends and curves from the sidewall and along the incident surface.

14. The liquid crystal display as recited in claim 13, wherein the heatsink is configured from an aluminum extrusion, and the base of the heatsink is integrally formed with the deflector.

15. The liquid crystal display as recited in claim 12, wherein
the back frame includes a heatsink and a backboard;
the heatsink is disposed under the bottom surface of the waveguide;
the backboard is disposed under the heatsink so as to support the waveguide, the light source and the heatsink;
wherein the heatsink defines a compartment for receiving the light source in an area adjacent to the incident surface of the waveguide; and
the backboard includes a main slab which is parallel to the bottom surface of the heatsink, and a sidewall perpendicular to the main slab, the deflector extends and curves from the sidewall toward the incident surface of the waveguide.

16. The liquid crystal display as recited in claim 13, wherein the main slab, the sidewall and the deflector are integrally formed together.

17. The liquid crystal display as recited in claim 15, wherein the light source includes a printed circuit board and an LED unit, the printed circuit is disposed closely to a bottom of the compartment, and the LED is disposed on a top surface of the printed circuit board.

18. The liquid crystal display as recited in claim 12, wherein an end of the deflector in abutting against a transitional edge located between the incident surface and the refractive surface.

19. The liquid crystal display as recited in claim 12, wherein a surface of the deflector is provided with a refractive mirror or a metallic layer.

20. The liquid crystal display as recited in claim 12, wherein the deflector has a planar configuration and has an angle ranging from twenty (20) to seventy (70) degrees with respect to a horizontal direction.
